(19) United States
(12) Patent Application Publication
(10) Pub. No.: US 2009/0110981 A1
(43) Pub. Date: Apr. 30, 2009

(54) Fuel Cell System and Operating Method of Fuel Cell System

(75) Inventors: Tomohiro Saito, Aichi-ken (JP); Tadaichi Matsumoto, Aichi-ken (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 11/992,521

(22) PCT Filed: Oct. 4, 2006
(86) PCT No.: PCT/JP2006/320245

§ 371 Date: Mar. 25, 2008

(30) Foreign Application Priority Data
Oct. 5, 2005 (JP) 2005-291914

(51) Int. Cl. H01M 8/04

(52) U.S. Cl. 429/22; 429/17

(57) ABSTRACT

In a fuel cell system equipped with a fluid supply device, such as a pump, in a fluid supply system to fuel cells, an insufficient supply of a fluid to the fuel cells is avoided by taking into account a fluctuation in fluid supply induced by operation of the fluid supply device. A procedure of gas supply to the fuel cells makes an increasing correction to increase supply amounts of hydrogen gas and the air according to a fluctuation in gas supply induced by operations of pumps and a blower, and actually supplies the hydrogen gas and the air of the corrected supply amounts after the increasing correction. The fuel cells are under power generation control to obtain a required power generation current equivalent to a power generation demand, while receiving the hydrogen gas supply and the air supply of corrected supply amounts by increasing correction of gas supply base amounts corresponding to the required power generation current.

### TECHNICAL FIELD

The present invention relates to a fuel cell system including fuel cells and a supply device provided for supply of a fluid required for power generation by the fuel cells, as well as to an operating method of such a fuel cell system.

### BACKGROUND ART

Fuel cells generally have a stack structure of multiple unit cells. In each unit cell, an MEA (membrane electrode assembly) including an electrolyte layer with catalyst layers formed on both faces thereof is interposed between gas flow path-forming members for a fuel gas and an oxidizing gas. In the fuel cells of this stack structure, separate gas supply systems are provided for the fuel gas and the oxidizing gas to be supplied to the respective unit cells. A gas pressure-feeding device, such as a compressor, a pump, or a blower, is generally provided in each gas supply system to pneumatically supply the fuel gas or the oxidizing gas (for example, the air).

The level of power generation of the fuel cells is correlated to the supply amounts of the respective gases. In order to ensure an optimum output characteristic responding to respective gas supplies, the output (power generation amount) of the fuel cells is determined corresponding to the supply amounts of the respective gases by referring to this correlation (see, for example, Japanese Patent Laid-Open No. 2004-12059)

The gas pressure-feeding devices are driven to pneumatically supply the respective gases to the fuel cells to obtain the determined power generation amount. There is conventionally no specific consideration in a phenomenon induced by the operation of the gas pressure-feeding device. The gas pressure-feeding device drives its driving part to pneumatically supply the gas. The actual supply amount of the gas pneumatically supplied to the fuel cells is not constant at a set value but fluctuates about the set value in the course of operation of the gas pressure-feeding device. Namely the fuel cells receive the gas in the fluctuating supply amount. The fluctuation in gas supply amount causes a fluctuation in power generation of the fuel cells. Since the gas pressure-feeding device as the source of the fluctuation is located apart from the fuel cells, the fluctuation in gas supply amount affects the power generation of the fuel cells with a certain time lag.

Under power generation control to obtain a desired power generation amount with supply of a corresponding amount of the gas, the fluctuation in gas supply amount may causes the fuel cells to fall in a state of insufficient gas supply. The insufficient gas supply may lead to deterioration of the fuel cells and is thus to be avoided. The design of the gas pressure-feeding device free from such fluctuation in gas supply amount is, however, impractical, because of its complicated structure and the requirement for extreme accuracy and precision of its constituents. One applicable method controls power generation of the fuel cells with monitoring the fluctuation in gas supply amount. The procedure of such control, however, becomes undesirably complicated since consideration in time lag of the fluctuation is required.

This phenomenon is commonly found in both electrically-driven supply devices, such as a motor, and mechanically-driven supply devices, such as a gas pressure-feeding device of a piston reciprocating mechanism. The fluctuation in supply amount is induced by the operation of a liquid supply device as well as the operation of a gas supply device. The problem of such fluctuation is thus to be solved not only in the fuel cell system including the fuel cells receiving the supply of a fuel gas for power generation but in the fuel cell system including the fuel cells receiving the supply of a fuel liquid for power generation.

### DISCLOSURE OF THE INVENTION

In power generation of fuel cells with supply of a fluid required for the power generation by operating a supply device, there would thus be a demand for avoiding operation of the fuel cells in a state of insufficient fluid supply.

In order to accomplish at least part of the above and the other related demands, one aspect of the invention pertains to an operating method of a fuel cell system that includes fuel cells and a supply device provided for supply of a fluid required for power generation by the fuel cells. The operating method refers to a relation of a power generation amount to a supply amount of the fluid supplied to the fuel cells, and performs drive control of driving the supply device to supply the fluid of a supply amount corresponding to a power generation demand required for the fuel cells and power generation control of driving the fuel cells to obtain a power generation amount equivalent to the power generation demand. There is a fluctuation in fluid supply induced by operation of the supply device, so that the drive control of the supply device and the power generation control of the fuel cells are changed according to the following procedure.

The operating method estimates a fluctuation in fluid supply induced by operation of the supply device based on an operating condition of the supply device, and changes at least either the drive control of the supply device or the power generation control of the fuel cells according to the estimated fluctuation in fluid supply to make a correction of relatively increasing a rate of the supply amount of the fluid to the power generation amount. The correction made here is at least either an increasing correction of increasing the supply amount of the fluid according to the estimated fluctuation in fluid supply or a decreasing correction of decreasing the power generation amount according to the estimated fluctuation in fluid supply. The operating condition of the supply device used for such correction may be directly measured or detected or may be specified by a driving signal output to the supply device. In the increasing correction of the supply amount of the fluid, the drive control of the supply device is changed to supply the fluid of a corrected supply amount after the increasing correction. In the decreasing correction of the power generation amount, the power generation control of the fuel cells is changed to obtain a corrected power generation amount after the decreasing correction.

The operating method according to this aspect of the invention relatively increases the rate of the supply amount of the fluid to the power generation amount and supplies the fluid at this relatively increased rate to the fuel cells under the power generation control for satisfying the power generation demand. Namely the supply amount of the fluid actually supplied to the fuel cells exceeds a required supply amount of the fluid corresponding to the power generation demand. This arrangement effectively prevents the fuel cells from being operated in a state of insufficient fluid supply. In the case of power generation of the fuel cells with supply of the fluid at the supply amount corresponding to the power generation demand, the fuel cells are operated to obtain a power generation amount lower than the power generation demand. This also effectively prevents the fuel cells from being operated in the state of insufficient fluid supply. The operating method of the fuel cell system according to this aspect of the invention thus effectively prevents the fuel cells from being operated in the state of insufficient fluid supply by the simple increasing correction of the supply amount of the fluid based on the fluctuation in fluid supply or by the simple decreasing correction of the power generation amount based on the fluctuation in fluid supply.

In order to accomplish at least part of the above and the other related demands, another aspect of the invention is directed to a fuel cell system that includes fuel cells and a supply device provided for supply of a fluid required for power generation by the fuel cells, where the supply device is operated to supply the fluid to the fuel cells for power generation. The fuel cell system refers to a relation of a power generation amount to a supply amount of the fluid supplied to the fuel cells and computes a supply amount of the fluid corresponding to a power generation demand required for the fuel cells. In the fuel cell system, in drive control of the supply device to supply the computed supply amount of the fluid by an equipment control module, a supply correction module estimates a fluctuation in fluid supply induced by operation of the supply device based on an operating condition of the supply device and makes an increasing correction of the computed supply amount according to the estimated fluctuation in fluid supply.

In the fuel cell system according to this aspect of the invention, the corrected supply amount of the fluid by the increasing correction of the supply amount corresponding to the power generation demand is supplied to the fuel cells under power generation control for satisfying the power generation demand. The fuel cell system according to this aspect of the invention thus effectively prevents the fuel cells from being operated in the state of insufficient fluid supply by the simple increasing correction of the supply amount of the fluid based on the fluctuation in fluid supply.

In order to accomplish at least part of the above and the other related demands, still another aspect of the invention is directed to another fuel cell system, where a supply amount detection module detects a supply amount of the fluid supplied to the fuel cells, and a power generation amount computation module refers to a relation of a power generation amount to the supply amount of the fluid supplied to the fuel cells and computes a power generation amount corresponding to the detected supply amount of the fluid. A power generation control module controls power generation of the fuel cells to supply electric power generated by the fuel cells to an external load. In the power generation control of the fuel cells to obtain the computed power generation amount by the power generation control module, a power generation correction module estimate a fluctuation in fluid supply induced by operation of the supply device based on an operating condition of the supply device and makes a decreasing correction of the computed power generation amount according to the estimated fluctuation in fluid supply.

In the fuel cell system according to this aspect of the invention, in the case of power generation of the fuel cells at a power generation amount corresponding to a supply amount of the fluid supplied to the fuel cells, the fuel cells are controlled to perform the power generation at the corrected power generation amount after the decreasing correction. The fuel cell system according to this aspect of the invention thus effectively prevents the fuel cells from being operated in the state of insufficient fluid supply by the simple decreasing correction of the power generation amount based on the fluctuation in fluid supply.

In one preferable application of this aspect making the decreasing correction of the power generation amount, in the computation of the power generation amount corresponding to the supply amount of the fluid supplied to the fuel cells, the fuel cell system makes an increasing correction of the detected supply amount according to the estimated fluctuation in fluid supply and computes the power generation amount corresponding to a corrected supply amount after the increasing correction. In the correction of the power generation amount, the fuel cell system of this application makes the decreasing correction of the power generation amount computed corresponding to the corrected supply amount after the increasing correction by the power generation amount computation module, according to the estimated fluctuation in fluid supply. In the power generation control of the fuel cells, the fuel cell system of this application compares a power generation demand required for driving the external load with a corrected power generation amount after the decreasing correction and controls the operation of the fuel cells with the smaller between the power generation demand and the corrected power generation amount after the decreasing correction.

In the fuel cell system of this application, the supply amount of the fluid supplied to the fuel cells is subjected to the increasing correction based on the fluctuation in fluid supply. The power generation amount computed corresponding to the corrected supply amount of the fluid represents a maximum power generation amount with the supply amount of the fluid supplied to the fuel cells. The maximum power generation amount (the power generation amount computed corresponding to the corrected supply amount of the fluid after the increasing correction) is then subjected to the decreasing correction based on the fluctuation in fluid supply. When the corrected maximum power generation amount after the decreasing correction is smaller than the power generation demand, the operation of the fuel cells is controlled with the corrected maximum power generation amount after the decreasing correction. When the corrected maximum power generation amount is not smaller than the power generation demand, on the other hand, the operation of the fuel cells is controlled with the power generation demand. Compared with the conventional operation control of the fuel cells with the power generation demand, this arrangement effectively prevents the fuel cells from being operated in the state of insufficient fluid supply, while maximizing the power generation amount and ensuring generation of electric power to satisfy the power generation demand.

In one preferable embodiment of the fuel cell system according to the invention, a circulation system is provided with a recycle flow path to flow back a fuel fluid discharged from the fuel cells to a fuel fluid supply system connecting with the fuel cells. A circulation pump is provided in the recycle flow path of the circulation system to recycle the discharged fuel fluid. The fuel cell system of this embodiment estimates a fluctuation in recycle flow of the discharged fuel fluid induced by operation of the circulation pump and makes the increasing correction of the supply amount of the fluid or the decreasing correction of the power generation amount according to the estimated fluctuation in recycle flow and the estimated fluctuation in fluid supply.

The fluid flowed through the circulation system and back to the fuel fluid supply system is not restricted to the discharged fuel fluid but also includes a gas produced as a result of power generation by the fuel cells, for example, a nitrogen gas produced by a reaction of a hydrogen-containing gas supplied to anodes of the fuel cells with an oxygen-containing air supplied to cathodes of the fuel cells as the fuel fluids. The flow rate (supply amount) detected in the downstream of a joint of the circulation system with the fuel fluid supply system includes a flow rate of nitrogen gas making no contribution to power generation. The supply amount of the fuel fluid is thus detected in the upstream of the joint of the circulation system with the fuel fluid supply system. There is a fluctuation in flow rate (recycle flow) induced by the operation of the circulation pump provided in the circulation system. This leads to a fluctuation in recycle amount of the discharged fuel fluid and thereby a fluctuation in overall supply amount of the fuel fluid to the fuel cells. This fluctuation, however, does not affect the detection of the supply amount of the fuel fluid. The increasing correction of the fluid supply amount alone or the decreasing correction of the power generation amount alone based on the operating condition of the supply device having the fluctuation in supply amount of the fuel fluid may cause the fuel cells to fall in the state of insufficient fluid supply by the fluctuation in recycle amount of the discharged fuel fluid induced by the operation of the circulation pump. The increasing correction of the fluid supply amount or the decreasing correction of the power generation amount by taking into account the fluctuation in recycle amount of the discharged fuel fluid induced by the operation of the circulation pump desirably prevents the fuel cells from being operated in the state of insufficient fluid supply by the circulation pump operation-induced fluctuation in recycle amount of the discharged fuel fluid.

Any driving mechanism may be adopted in the fluid supply device and the circulation pump, for example, a rotating mechanism like a vane pump or a gear pump or a cylinder reciprocating mechanism. The fluid supplied to the fuel cells for power generation may be a gas or a liquid. The technique of the invention is preferably applied to both a fuel gas and a fuel liquid, since there is a fluctuation in supply amount of the fuel gas or the fuel liquid induced by operation of the supply device.

The technique of the invention is not restricted to the fuel cell system or its operating method but may also be actualized by a fluid supply device configured to make an increasing correction of a supply amount of a fluid to the fuel cells. In the change of at least either the drive control of the supply device or the power generation control of the fuel cells according to the estimated fluctuation in fluid supply, the relation of the power generation amount to the supply amount of the fluid supplied to the fuel cells may be corrected in a direction of relatively increasing the rate of the supply amount of the fluid to the power generation amount.

### BRIEF DESCRIPTION OF THE DRAWINGS

FIG. 1 is a block diagram schematically illustrating the configuration of a fuel cell system 100 according to one embodiment of the invention;

FIG. 2 is a flowchart showing a gas supply control routine;

FIG. 3 shows a correlation of a pump operation-induced pulsation status (range of fluctuation) to an operating point HNMs of a hydrogen gas supply pump 230 provided in an anode gas supply conduit 24, as well as a correlation of a correction amount (increasing correction amount) to the range of fluctuation;

FIG. 4 shows a correlation of a pump operation-induced pulsation status (range of fluctuation) to an operating point HNJs of a circulation pump 250 provided in a gas circulation flow path 28, as well as a correlation of a correction amount (increasing correction amount) to the range of fluctuation;

FIG. 5 shows a correlation of a blower operation-induced pulsation status (range of fluctuation) to an operating point ONs of a blower 30 provided in a cathode gas supply conduit 34, as well as a correlation of a correction amount (increasing correction amount) to the range of fluctuation;

FIG. 6 shows a relation of increasing correction of gas supply to a required power generation current Im;

FIG. 7 is a flowchart showing another gas supply control routine executed in another embodiment; and

FIG. 8 is a flowchart showing a power generation control routine executed in another embodiment.

### BEST MODES OF CARRYING OUT THE INVENTION

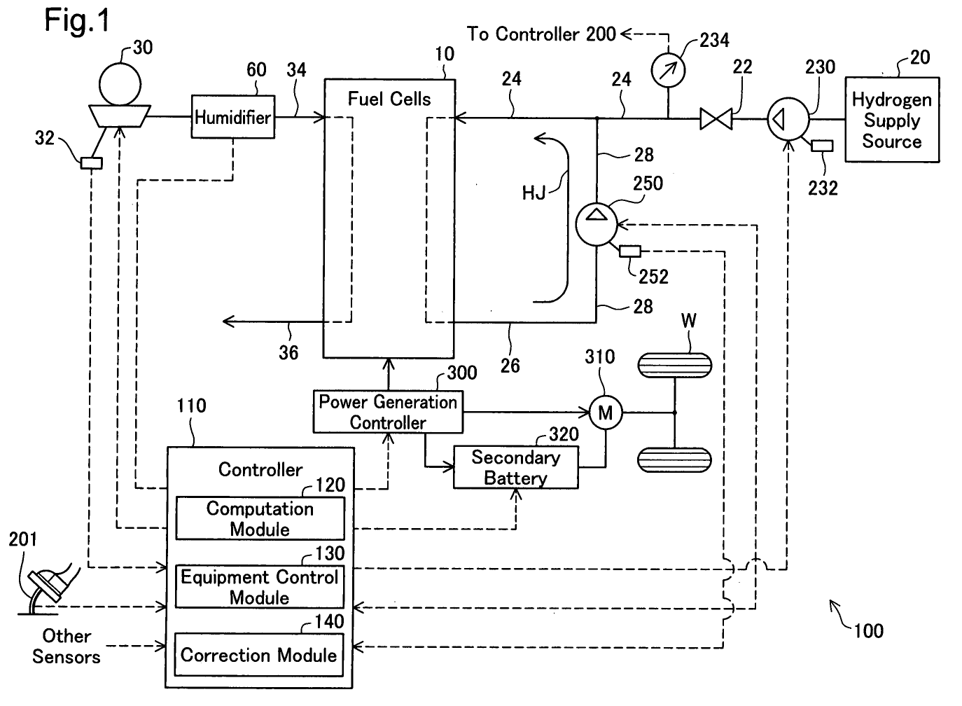

Some modes of carrying out the invention are described below with reference to the accompanied drawings. FIG. 1 is a block diagram schematically illustrating the configuration of a fuel cell system 100 according to one embodiment of the invention. The fuel cell system 100 mainly includes fuel cells 10, a hydrogen supply source 20, a blower 30, a controller 110, a humidifier 60, a circulation pump 250, and a power generation controller 300.

The fuel cells 10 are hydrogen separation membrane fuel cells and have a stack structure of multiple unit cells as constituent units. Each unit cell has a hydrogen electrode (hereafter referred to as anode) and an oxygen electrode (hereafter referred to as cathode) arranged across an electrolyte membrane. The fuel cells 10 generate electric power through an electrochemical reaction of a hydrogen-containing fuel gas (hereafter referred to as anode gas) supplied to the anodes of the respective unit cells with an oxygen-containing oxidizing gas supplied to the cathodes of the respective unit cells. The electric power generated by the fuel cells 10 is supplied to a motor 310 as an external load via the power generation controller 300 of controlling the power generation of the fuel cells 10. The fuel cells 10 are not restricted to the hydrogen separation membrane fuel cells but may be any of other diverse fuel cells, for example, polymer electrolyte fuel cells, alkaline fuel cells, phosphoric acid fuel cells, or molten carbonate fuel cells.

The blower 30 is used to supply the air as the oxidizing gas to the cathodes of the fuel cells 10. The blower 30 is connected to the cathodes of the fuel cells 10 via a cathode gas supply conduit 34, and the operating condition of the blower 30 is detected by a rotation speed sensor 32 and is output to an equipment control module 130 of the controller 110. The cathode gas supply conduit 34 is provided with a humidifier 60. The air compressed by the blower 30 is humidified by the humidifier 60 and is fed to the fuel cells 10. The fuel cells 10 have a cathode off gas conduit 36, through which an exhaust gas from the cathodes after the electrochemical reaction (hereafter referred to as cathode off gas) is discharged outside.

The hydrogen supply source 20 supplies a hydrogen gas reserved therein or a hydrogen gas produced by a reforming reaction of, for example, an alcohol, a hydrocarbon, or an aldehyde, to the fuel cells 10. The hydrogen supply source 20 is connected to the anodes of the fuel cells 10 via an anode gas supply conduit 24. A hydrogen gas supply pump 230 and a regulator 22 are provided in the anode gas supply conduit 24 in the vicinity of the hydrogen supply source 20. The hydrogen gas supply pump 230 is located in the upstream of the regulator 22 in a flow direction of the hydrogen gas. Any of various pumps, for example, a vane pump with rotation of a vane-equipped rotor, a gear pump, and a piston pump may be adopted for the hydrogen gas supply pump 230 to pressure-feed the hydrogen gas to the fuel cells 10. The amount of the pressure-fed hydrogen gas (supply amount) is measured by a gas flow meter 234 located in the downstream of the regulator 22 in the anode gas supply conduit 24. The hydrogen gas supply pump 230 is under control of the equipment control module 130 (described later), and the operating condition of the hydrogen gas supply pump 230 is detected by a rotation speed sensor 232 and is output to the equipment control module 130.

The high-pressure hydrogen gas supplied from the hydrogen supply source 20 to the anode gas supply conduit 24 is regulated by the regulator 22. The regulated hydrogen gas is fed as the anode gas to the anodes of the fuel cells 10. A pressure level of the regulated hydrogen gas is adequately set according to the magnitude of a load connected to the fuel cells 10.

The fuel gas supplied to the fuel cells 10 may be allowed to contain another gas in addition to the hydrogen gas according to the characteristic of the electrolyte membranes adopted in the fuel cells 10. The fuel for power generation may be provided in a liquid form, instead of the gas form. In this case, the hydrogen gas supply pump 230 is replaced by a fluid pump.

The fuel cells 10 also have an anode off gas conduit 26 at their anode side. An exhaust gas from the anodes after the electrochemical reaction (hereafter referred to as anode off gas) flows through the anode off gas conduit 26 and a gas circulation flow path 28 and is returned to the anode gas supply conduit 24 to be recycled to the fuel cells 10. The gas circulation flow path 28 is provided with a circulation pump 250, which is activated to circulate and recycle the anode off gas as shown by an arrow HJ in FIG. 1. Any of various pumps, for example, a vane pump, a gear pump, or a piston pump may be adopted for the circulation pump 250.

The circulation pump 250 is designed to adjust (set) the amount of anode off gas (recycled amount) by varying the rotation speed of a driving part, such as a rotor. Such setting enables regulation of an anode gas recycle rate as a ratio of the amount of anode off gas flowed through the gas circulation flow path 28 into the fuel cells 10 to the amount of anode gas supplied from the hydrogen supply source 20. The hydrogen gas contained in the anode off gas is thus circulated and is reused as the anode gas for power generation. The circulation pump 250 is under control of the equipment control module 130 (described later), and the operating condition of the circulation pump 250 is detected by a rotation speed sensor 252 and is output to the equipment control module 130.

The power generation controller 300 controls the power generation of the fuel cells 10 to supply the electric power generated by the fuel cells 10 to the motor 310 for rotating drive wheels W. The motor 310 is connected to receive a supply of electric power accumulated in a secondary battery 320, as well as the supply of electric power generated by the fuel cells 10. The motor 310 rotates the drive wheels W with a supply of electric power via the power generation controller 300 or with a supply of electric power via the secondary battery 320. The state of charge or the charge level of the secondary battery 320 is measured by a charge level sensor (not shown) and is output as a sensor output to the controller 110.

The controller 110 is constructed as a microcomputer-based logic circuit and includes a CPU (not shown) configured to execute various operations according to preset control programs, a ROM (not shown) designed to store in advance control programs and control data required for the various operations executed by the CPU, a RAM (not shown) designed to allow diverse data required for the various operations executed by the CPU to be temporarily written in and read from, and an input output port (not shown) designed to input and output various signals. The controller 110 receives information on a load demand, for example, information from an accelerator sensor 201 detecting the driver's depression amount of an accelerator pedal, outputs driving signals to the relevant constituents of the fuel cell system 100 including the blower 30, the humidifier 60, the hydrogen gas supply pump 230, and the circulation pump 250, and controls the operations of these relevant constituents by taking into account the driving status of the whole fuel cell system 100.

The controller 110 works in combination with a preset program (described below) to function as a computation module 120 of computing a hydrogen gas supply amount and a power generation demand from sensor outputs, the equipment control module 130 of controlling the operations of various equipment, for example, the hydrogen gas supply pump 230, the circulation pump 250, and the blower 30, and a correction module 140 of calculating correction amounts in various states, for example, those in a pump operating state and in a fuel cell power generation state.

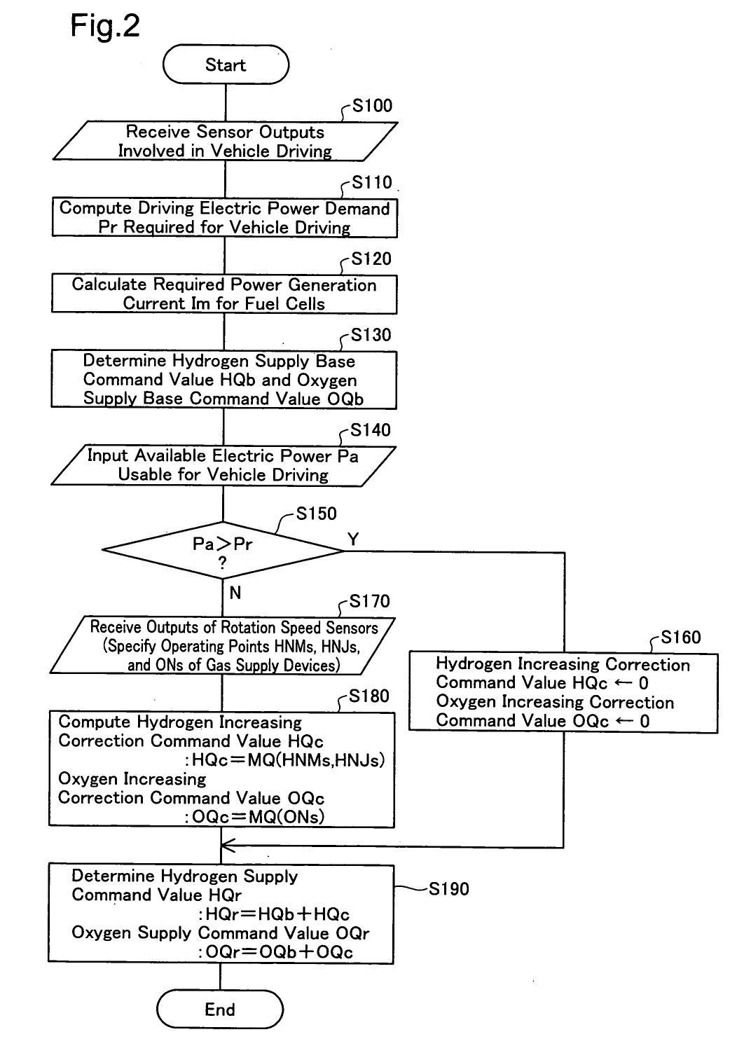

The description regards the details of gas supply control performed in the fuel cell system 100 having the configuration explained above. FIG. 2 is a flowchart showing a gas supply control routine.

The gas supply control of FIG. 2 simultaneously controls the supply of the hydrogen gas to the anodes and the supply of the air to the cathodes. The controller 110 first receives various sensor outputs involved in vehicle driving, for example, the output of the accelerator sensor 201 (step S100) and computes a driving electric power demand Pr required for vehicle driving from the received sensor outputs (step S110). According to a concrete procedure, the controller 110 stores in advance a map of correlating the driving electric power demand Pr to the sensor outputs, for example, the depression amount of the accelerator pedal and the vehicle speed, and refers to this map to compute the driving electric power demand Pr corresponding to the given sensor outputs.

The controller 110 subsequently calculates a required power generation current Im for the fuel cells 10 from the computed driving electric power demand Pr (step S120) and determines a hydrogen supply base command value HQb and an oxygen supply base command value OQb for attaining the required power generation current Im (step S130). According to a concrete procedure, these gas supply base command values HQb and OQb are determined by referring to a map stored in advance to correlate the respective gas supply base command values HQb and OQb to relevant factors, for example, the power generation current (required power generation current) and the temperature of the fuel cells. Each of the gas supply base command values HQb and OQb is given as the sum of a theoretically required supply amount to satisfy the required power generation current and a marginal supply amount to accelerate the progress of the electrochemical reaction for power generation.

The controller 110 then inputs an available electric power Pa, which is computed in advance by another computation routine (not shown) (step S140) and compares the available electric power Pa with the computed driving electric power demand Pr (step S150). The available electric power Pa represents an overall electric power suppliable by the fuel cell system 100 as a whole and is given as the sum of a power generation demand or an amount of electric power to be generated by the fuel cells 10 and an amount of electric power accumulated in the secondary battery 320.

In response to an affirmative answer at step S150 based on the comparison result of Pa>Pr, the fuel cell system 100 ensures sufficient supply of electric power as a whole. On condition that the secondary battery 320 has a sufficient amount of accumulated electric power, the driving electric power demand Pr required for vehicle driving may be coverable even when the fuel cells 10 are operated to generate a less amount of electric power than the power generation demand. In such cases, no gas supply correction is required. The controller 110 then sets both an increasing correction command value HQc for the supply amount of the hydrogen gas and an increasing correction command value OQc for the supply amount of the air to 0 at step S160 and proceeds to step S190.

In response to a negative answer at step S150, on the other hand, the controller 110 receives the outputs of the relevant equipment involved in gas supply or more specifically receives the outputs of the rotation speed sensors for the hydrogen gas supply pump 230 and the circulation pump 250 in the hydrogen gas supply system and for the blower 30 in the air supply system (step S170) and specifies the received outputs (rotation speeds) as operating points of these equipment. The specified operating points include an operating point HNMs of the hydrogen gas supply pump 230 in the anode gas supply conduit 24 and an operating point HNJs of the circulation pump 250 in the gas circulation flow path 28 in the hydrogen gas supply system and an operating point ONs of the blower 30 in the air supply system.

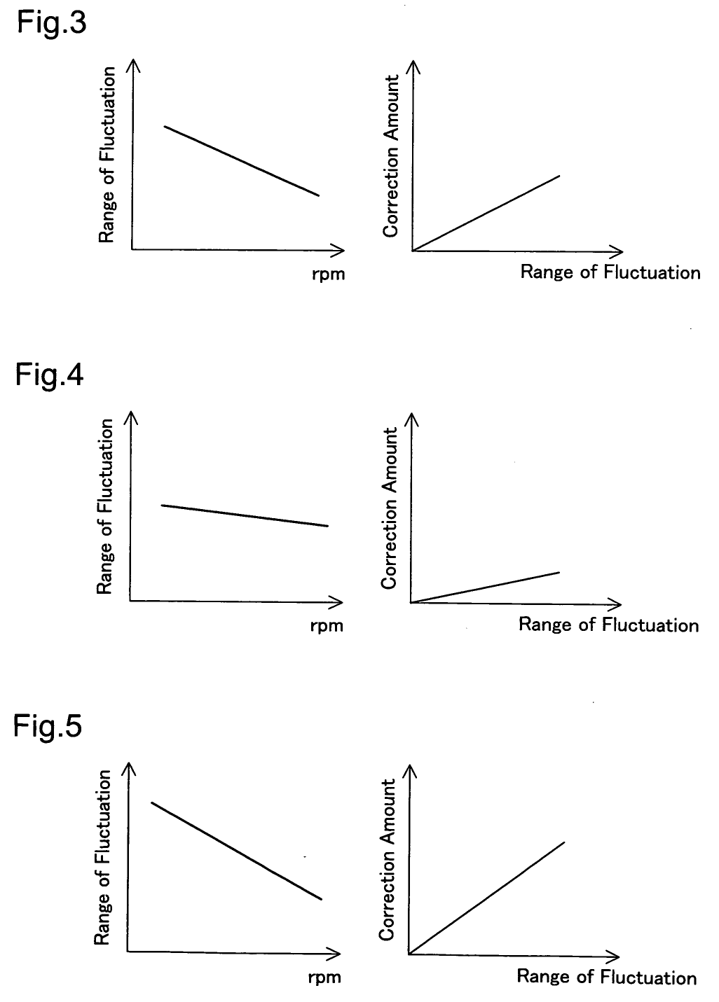

At subsequent step S180, the increasing correction command values HQc and OQc of the hydrogen gas and the air are computed with regard to the specified operating points. FIG. 3 shows a correlation of a pump operation-induced pulsation status (range of fluctuation) to the operating point HNMs of the hydrogen gas supply pump 230 provided in the anode gas supply conduit 24, as well as a correlation of a correction amount (increasing correction amount) to the range of fluctuation. FIG. 4 shows a correlation of a pump operation-induced pulsation status (range of fluctuation) to the operating point HNJs of the circulation pump 250 provided in the gas circulation flow path 28, as well as a correlation of a correction amount (increasing correction amount) to the range of fluctuation. FIG. 5 shows a correlation of a blower operation-induced pulsation status (range of fluctuation) to the operating point ONs of the blower 30 provided in the cathode gas supply conduit 34, as well as a correlation of a correction amount (increasing correction amount) to the range of fluctuation.

The pumps and the blower functioning as gas supply devices have different structures but all include a driving (rotating) part directly involved in gas supply. Each of these gas supply devices causes a fluctuation in gas supply in the course of operation of the driving part. The fluctuation in gas supply is correlated to the driving condition of the driving part (that is, the rotation speed in this embodiment). The graphs of FIGS. 3 to 5 represent these correlations. In general, the increased rotation speed leads to the less fluctuation in gas supply. The range of fluctuation in gas supply has a variation according to the pump/blower structures and specifications. The period of fluctuation also has a variation according to the rotation speed. The range of fluctuation, however, has a significantly greater effect on the fluctuation in gas supply to the fuel cells 10. According to a concrete procedure of the embodiment, the controller 110 thus stores in advance the illustrated correlation of the range of fluctuation with regard to each pump/blower in the form of a table or a map. In the hydrogen gas supply system, the increasing correction command value HQc of the supply amount of the hydrogen gas is computed based on the operating point HNMs of the hydrogen gas supply pump 230 in the anode gas supply conduit 24 and the operating point HNJs of the circulation pump 250 in the gas circulation flow path 28. In the air supply system, the increasing correction command value OQc of the supply amount of the air is computed based on the operating point ONs of the blower 30 in the cathode gas supply conduit 34. The fluctuation in gas supply in the course of operation of the pump/blower is thus estimable according to the driving condition of the driving part.

The controller 110 sums up the gas supply base command value determined at step S130 and the increasing correction command value computed at step S180 with regard to the hydrogen gas and the air to determine gas supply command values after the increasing correction (that is, a hydrogen supply command value HQr and an oxygen supply command value OQr) (step S190). The gas supply control routine is then terminated. The controller 110 outputs the gas supply command values determined at step S190 to the hydrogen gas supply pump 230 and the circulation pump 250 in the hydrogen gas supply system and to the blower 30 in the air supply system. In the hydrogen gas supply system, a specific amount of the hydrogen gas determined by the pump operation-based increasing correction of the hydrogen supply base amount determined to satisfy the power generation demand is supplied to the anodes of the fuel cells 10. In the air supply system, a specific amount of the air determined by the pump operation-based increasing correction of the oxygen supply base amount determined to satisfy the power generation demand is supplied to the cathodes of the fuel cells 10.

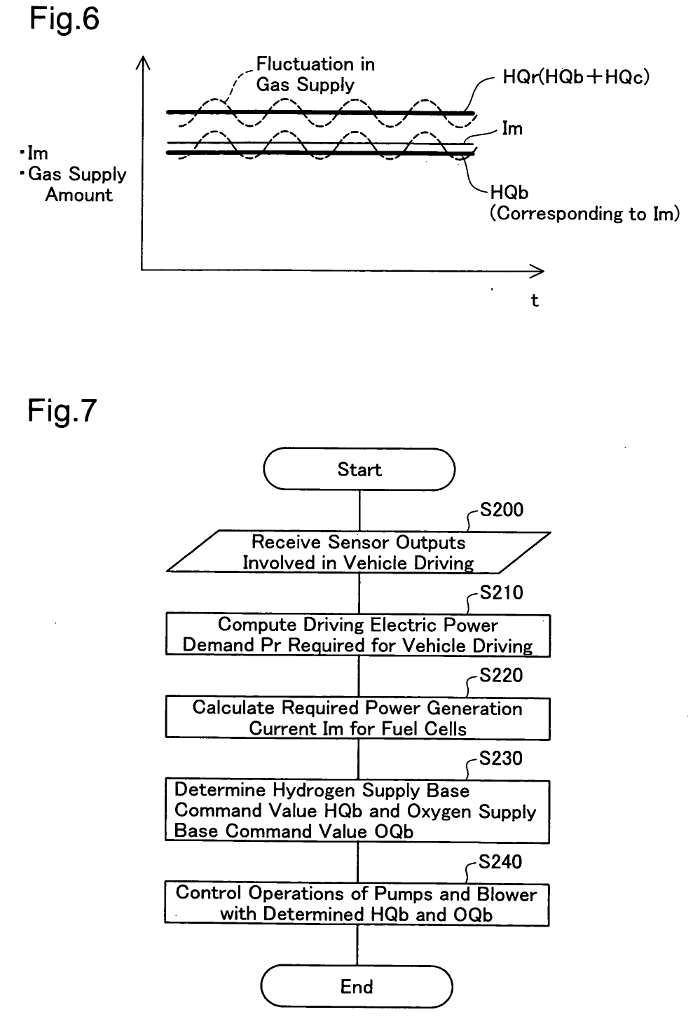

In the fuel cell system 100 of the embodiment described above, the processing of steps S170 to S190 makes the increasing correction of the gas supply base amount by taking into account the pump/blower operation-induced fluctuation in gas supply with regard to both the hydrogen gas and the air and supplies the determined supply amounts of the hydrogen gas and the air after the increasing correction. The fuel cells 10 are controlled by the power generation controller 300 to obtain the required power generation current Im based on the power generation demand. The supply amounts of the hydrogen gas and the air to be actually supplied to the fuel cells 10 are regulated (step S190) by the increasing correction of the respective gas supply base amounts of the hydrogen gas and the air determined corresponding to the required power generation current Im (step S130). This relation is explained in detail with reference to FIG. 6. FIG. 6 shows a relation of the increasing correction of gas supply to the required power generation current Im.

In the description below, it is assumed that the fuel cells 10 are operated with the required power generation current Im and that the supply amount of the hydrogen gas to the fuel cells 10 is equal to the hydrogen supply base command value HQb corresponding to the required power generation current Im. The hydrogen supply base command value HQb is subjected to the increasing correction with the hydrogen increasing correction command value HQc computed according to the operating points of the hydrogen gas supply pump 230 and the circulation pump 250. The hydrogen supply command value HQr (hydrogen supply amount) to the fuel cells 10 is accordingly determined by increasing the hydrogen supply base command value HQb (hydrogen supply base amount) by the hydrogen increasing correction command value HQc. In the fuel cell system 100 of the embodiment, the fuel cells 10 are thus not operated in an insufficient gas supply operating state having the insufficient supply of hydrogen or insufficient supply of oxygen (insufficient supply of the air). The insufficient gas supply operating state having the insufficient supply of hydrogen or insufficient supply of oxygen (insufficient supply of the air) is readily avoidable by the simple increasing correction of the hydrogen gas supply and the air supply.

Even after such increasing correction, the pump operation causes a fluctuation in actual gas supply. As shown by a dotted-line curve in FIG. 6, the supply amount of the hydrogen gas to the fuel cells 10 fluctuates up and down about a certain supply amount corresponding to the hydrogen supply command value HQr. Keeping the range of fluctuation in gas supply shown by the dotted-line curve over the hydrogen supply base command value HQb corresponding to the required power generation current Im ensures effective avoidance of the insufficient supply of the hydrogen gas. This discussion is also applicable to the air supply. The gas increasing correction command value computed from the operating points of the pump/blower at step S180 is thus required to cover at least half of the range of fluctuation corresponding to the operating points (see FIGS. 3 to 5). The procedure of this embodiment sets the level of the increasing correction computed at step S180 to be 0.5-fold to 1.0-fold of the range of fluctuation corresponding to the operating points. This arrangement effectively prevents an unnecessarily excess level of the increasing correction for avoiding the insufficient gas supply, thus desirably saving the gas consumption and keeping the good fuel consumption.

Even if the range of fluctuation in gas supply shown by the dotted-line curve in FIG. 6 occasionally decreases below the hydrogen supply base command value HQb corresponding to the required power generation current Im, the increasing correction in gas supply to compensate for the pump/blower operation-induced fluctuation still effectively avoids the insufficient gas supply to the fuel cells 10, compared with the gas supply without the increasing correction.

The increasing correction of the hydrogen gas supply also takes into account a fluctuation in flow rate induced by the operation of the circulation pump 250 provided to recycle the anode off gas for the effective use of the unreacted hydrogen gas. This enables the precise increasing correction of the hydrogen gas supply and thus advantageously avoids the insufficient supply of the hydrogen gas to the fuel cells 10 due to the fluctuation in flow rate (fluctuation in recycle amount) induced by the operation of the circulation pump 250.

Without the increasing correction of the hydrogen gas supply and the air supply, the fuel cells 10 may be affected by the fluctuation in gas supply induced by the operations of the hydrogen gas supply pump 230 and the circulation pump 250 or by the operation of the blower 30 and may perform power generation with the insufficient gas supplies. In this insufficient gas supply operating state, although the fuel cells 10 are under operation control to satisfy the required power generation current Im, the insufficient supplies of the hydrogen gas and the air naturally decrease the allowable amount of power generation. This may cause a fluctuation in power output according to the driving condition of the vehicle and worsen the drivability. The procedure of the embodiment, however, controls the operation of the fuel cells 10 to satisfy the required power generation current Im with the increasing correction of the gas supply. This arrangement effectively prevents a fluctuation in power output and ensures the good drivability.

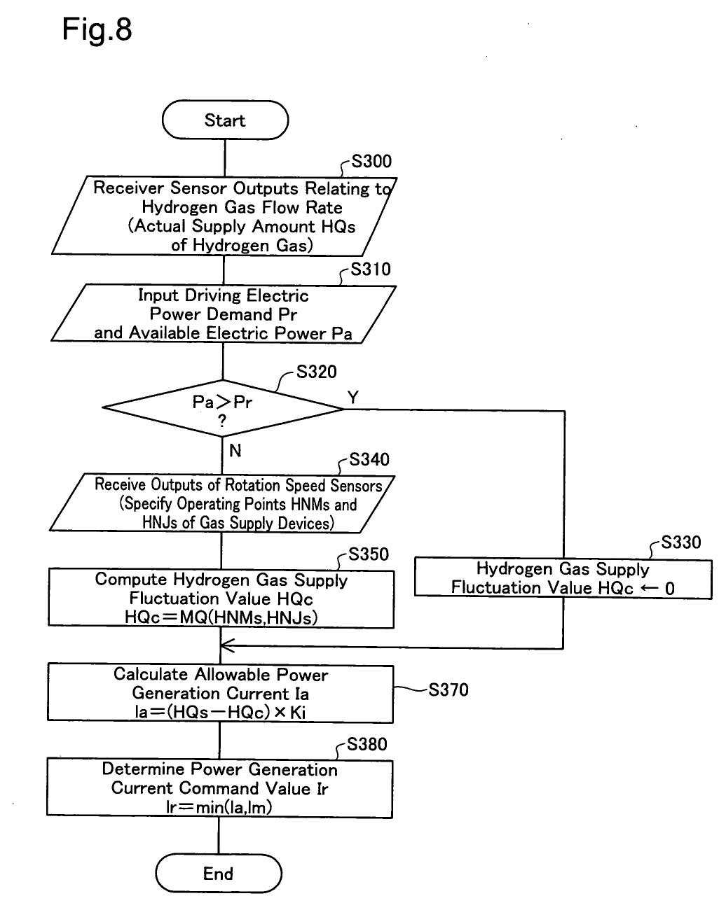

Another embodiment described below regards decreasing correction of the power generation current, whereas the above embodiment regards the increasing correction of the gas supply. FIG. 7 is a flowchart showing another gas supply control routine executed in another embodiment. FIG. 8 is a flowchart showing a power generation control routine executed in this embodiment. The hardware configuration of this embodiment is equivalent to the hardware configuration shown in FIG. 1.

The gas supply control routine of FIG. 7 executes the processing of steps S200 to S230, which is identical with the processing of steps S100 to S130 in the gas supply control routine of FIG. 2 described above. The controller 110 then controls the operations of the hydrogen gas supply pump 230 and the circulation pump 250 with the hydrogen supply base command value HQb, while controlling the operation of the blower 30 with the oxygen supply base command value OQb (step S240). The hydrogen gas supply pump 230 and the circulation pump 250 are accordingly operated to supply the hydrogen supply base command value HQb of the hydrogen gas to the anodes of the fuel cells 10. The blower 30 is operated to supply the oxygen supply base command value OQb of the air to the cathodes of the fuel cells 10. The hydrogen supply base command value HQb and the oxygen supply base command value OQb are determined to satisfy the required power generation current Im computed from the driving electric power demand Pr.

If there is no fluctuation in gas supply induced by the operation of the pump/blower, the fuel cells 10 are under simple power generation control to obtain the required power generation current Im. The operation of the pump/blower, however, causes a fluctuation in gas supply. The power generation of the fuel cells 10 is thus controlled according to the power generation control of FIG. 8.

In the power generation control routine of FIG. 8, the controller 110 first receives sensor outputs relating to the flow rate of the hydrogen gas or more specifically the outputs of the gas flow meter 234 provided in the anode gas supply flow path 24 and the rotation speed sensor 252 attached to the circulation pump 250 in the gas circulation flow path 28 to define the recycle amount of the hydrogen gas flowing through the gas circulation flow path 28 (step S300). The controller 110 computes a hydrogen gas flow rate HQs (that is, an actual supply amount of the hydrogen gas) including a recycle amount of the anode off gas containing unreacted hydrogen from the received sensor outputs. A concrete procedure of the computation calculates the recycle amount of the anode off gas from the rotation speed of the circulation pump 250 and determines the actual supply amount HQs of the hydrogen gas by taking into account the recycle rate of the recycle amount of the anode off gas to the hydrogen gas supply amount measured by the gas flow meter 234 and the content of hydrogen in the anode off gas.

The controller 110 subsequently inputs the driving electric power demand Pr computed in the gas supply control routine of FIG. 7 and an available electric power Pa, which is computed in advance by another computation routine (not shown) (step S310) and compares the available electric power Pa with the computed driving electric power demand Pr (step S320).

In response to an affirmative answer at step S320 based on the comparison result of Pa>Pr, the fuel cell system 100 ensures sufficient supply of electric power as a whole. In this state, computation of a fluctuation in gas supply is not required for the decreasing correction of the power generation current. The controller 110 accordingly sets a hydrogen gas supply fluctuation value HQc to 0 at step S330 and goes to step S190. The power generation control of FIG. 8 is performed for the decreasing correction of the power generation current. The gas supply-relating operations (for example, the input of the gas supply amount at step S300 and the computation of the gas supply fluctuation value at step S330) are essential for the hydrogen gas supplied to the anodes, although being additionally performed for the air supplied to the cathodes.

In response to a negative answer at step S320, on the other hand, the controller 110 receives the outputs of the relevant equipment involved in hydrogen gas supply, that is, the outputs of the rotation speed sensors for the hydrogen gas supply pump 230 and the circulation pump 250 in the hydrogen gas supply system (step S340) and specifies the received outputs (rotation speeds) as operating points of these equipment. The specified operating points include the operating point HNMs of the hydrogen gas supply pump 230 in the anode gas supply conduit 24 and the operating point HNJs of the circulation pump 250 in the gas circulation flow path 28.

At subsequent step S350, the hydrogen gas supply fluctuation value HQc is computed from the specified operating points for calculation of an allowable power generation current by taking into account the pump operation-induced fluctuation in gas supply as explained later. Like the processing of step S180 in the gas supply control of FIG. 2, the procedure of computation refers to a table or a map representing the fluctuation characteristics in gas supply shown in FIGS. 3 and 4 and computes the hydrogen gas supply fluctuation value HQc corresponding to the operating point HNMs of the hydrogen gas supply pump 230 in the anode gas supply conduit 24 and the operating point HNJs of the circulation pump 250 in the gas circulation flow path 28. The recycle amount of the anode off gas (that is, the circulation amount of unreacted hydrogen) changes according to the operating condition of the circulation pump 250 in the gas circulation flow path 28. A recycle rate of the anode off gas determined according to the operating points of the hydrogen gas supply pump 230 and the circulation pump 250 may thus be used as a contribution of the operating point HNJs of the circulation pump 250 to the hydrogen gas supply fluctuation value HQc. The higher recycle rate represents the higher circulation amount of unreacted hydrogen contained in the anode off gas. The hydrogen gas supply fluctuation value HQc is accordingly determinable corresponding to an increase in circulation amount of unused hydrogen. The hydrogen gas supply fluctuation value HQc represents a fluctuation in gas supply induced by the pump operations and is thus equivalent to the hydrogen increasing correction command value HQc computed at step S180 in the gas supply control of FIG. 2.

After computation of the hydrogen gas supply fluctuation value HQc, the controller 110 calculates an allowable power generation current Ia in the state of hydrogen gas supply of the hydrogen supply base command value HQb determined in the gas supply control of FIG. 7 to the anodes of the fuel cells 10 (step S370). The calculation of the allowable power generation current Ia subtracts the hydrogen gas supply fluctuation value HQc computed at step S350 from the actual supply amount HQs of the hydrogen gas computed at step S300 and multiplies the result of the subtraction by a correction coefficient Ki, which is a preset constant for converting a gas supply amount into an electric current value. The result of the subtraction represents a minimum hydrogen supply amount with consideration of the pump operation-induced fluctuation in gas supply in the state of hydrogen gas supply of the hydrogen supply base command value HQb determined in the gas supply control of FIG. 7 to the anodes of the fuel cells 10.

The controller 110 then compares the calculated allowable power generation current Ia with the required power generation current Im computed from the driving electric power demand Pr and sets the smaller power generation current to a power generation current command value Ir to be given to the fuel cells 10 (step S380). The power generation control routine is here terminated. The controller 110 outputs the power generation current command value Ir set at step S380 to the power generation controller 300. The fuel cells 10 accordingly receive the hydrogen gas supply and the air supply of the gas supply base command values determined to satisfy the required power generation current Im (steps S230 and S240 in FIG. 7), while being under power generation control by the power generation controller 300 to obtain a power generation current corresponding to the power generation current command value Ir.

The power generation current obtained here is equivalent to the smaller selected between the allowable power generation current Ia and the required power generation current Im. Adequately setting the hydrogen gas supply fluctuation value HQc used for calculation of the allowable power generation current Ia according to the operating conditions of the pumps enables the allowable power generation current Ia to be kept below the required power generation current Im in the ordinary driving state of the vehicle. The fuel cells 10 are thus under power generation control to obtain the allowable power generation current Ia that is smaller than the required power generation current Im, with receiving the hydrogen gas supply and the air supply of the hydrogen supply base command value HQb and the oxygen supply base command value OQb determined to satisfy the required power generation current Im. In the fuel cell system of this embodiment, the fuel cells 10 are not operated in the insufficient gas supply operating state having the insufficient supply of hydrogen or insufficient supply of oxygen (insufficient supply of the air). The insufficient gas supply operating state having the insufficient supply of hydrogen or insufficient supply of oxygen (insufficient supply of the air) is readily avoidable by the simple decreasing correction of the power generation current (steps S350 to S370). Adequate setting of the hydrogen gas supply fluctuation value HQc enables the allowable power generation current Ia to be set smaller than but closer to the required power generation current Im. This arrangement desirably enables generation of the maximum possible power generation current while effectively avoiding the insufficient gas supply to the fuel cells 10.

Even if the required power generation current Im is smaller than the allowable power generation current Ia and is selectively set to the power generation current command value Ir (step S380), the decreasing correction of the power generation current to compensate for the pump/blower operation-induced fluctuation still effectively avoids the insufficient gas supply to the fuel cells 10, compared with the gas supply without the decreasing correction. The required power generation current Im is obtainable by power generation of the fuel cells 10 in this state.

The decreasing correction of the power generation current takes into account the fluctuation in gas supply induced by the operation of the circulation pump 250 (steps S350 to S370). This enables the precise decreasing correction of the power generation current and advantageously avoids the insufficient gas supply to the fuel cells 10. With a view to considering the fluctuation in gas supply, the minimum gas supply amount obtained by subtraction of the gas supply fluctuation value HQc (step S350) from the actual supply amount HQs of the hydrogen gas (step S300) is used for calculation of the allowable power generation current Ia. The minimum gas supply amount represents a lower limit in the range of fluctuation in hydrogen gas supply of the actual supply amount HQs. The calculated allowable power generation current Ia is thus naturally smaller than an expected level of power generation current with the hydrogen gas of the actual supply amount HQs. The selective setting of the allowable power generation current Ia to the power generation current command value Ir thus effectively prevents power generation with the insufficient gas supply.

In the decreasing correction of the power generation current, detection of the actual supply amount of the hydrogen gas is required for calculation of the allowable power generation current Ia. The procedure of this embodiment uses the outputs of the gas flow meter 234 provided in the anode gas supply conduit 24 and the rotation speed sensor 252 for the circulation pump 250 provided in the gas circulation flow path 28 for the computation of the actual supply amount HQs of the hydrogen gas. This enables the circulation amount of unreacted hydrogen (the recycle amount of the anode off gas) to be reflected on the actual supply amount HQs of the hydrogen gas. The allowable power generation current Ia calculated from the hydrogen gas supply fluctuation value HQc as the decreasing correction based on the fluctuation in gas supply is thus adequate for the hydrogen gas supply to the anodes of the fuel cells 10. This desirably enhances the calculation reliability of the allowable power generation current Ia.

The embodiments discussed above are to be considered in all aspects as illustrative and not restrictive. There may be many modifications, changes, and alterations without departing from the scope or spirit of the main characteristics of the present invention.

In the fuel cell system of the above embodiment, the hydrogen gas and the air are respectively supplied to the anodes and to the cathodes of the fuel cells 10. The technique of the invention is applicable to fuel cells of another structure designed to receive a supply of a liquid fuel, for example, methanol, at the anodes. In this modification, a fluid pump is provided in a liquid fuel supply system to the anodes, and increasing correction in fluid supply and decreasing correction of the power generation current are made according to the pump operation-induced fluctuation in fluid supply.

The technique of the invention is also applicable to a hydrogen gas supply device and an air supply device to make the increasing correction in gas supply as explained above with reference to FIGS. 2 to 6.

In the configuration of the fuel cell system of the embodiment, the anode off gas is flowed through the gas circulation flow path 28 to be recycled to the fuel cells 10. The technique of the invention may be applicable to a fuel cell system without such recycling function. In this modification, only the fluctuation in gas supply induced by the operation of the hydrogen gas supply pump 230 is to be considered in the increasing correction in hydrogen gas supply and the decreasing correction of the power generation current. A high-pressure hydrogen tank to enable hydrogen gas supply at a substantially constant flow rate may be adopted for the hydrogen supply source 20 for the supply of the hydrogen gas. The hydrogen gas supply pump 230 is thus not required in the anode gas supply conduit 24. In this case, only the fluctuation in gas supply induced by the operation of the circulation pump 250 is to be considered in the increasing correction in hydrogen gas supply and the decreasing correction of the power generation current.

The increasing correction in gas supply described with reference to FIG. 2 may be combined with the decreasing correction of the power generation current described with reference to FIGS. 7 and 8. Both or selected one of the increasing correction in gas supply and the decreasing correction of the power generation current may be adopted according to the operating conditions of the hydrogen gas supply pump 230 and the circulation pump 250 (fluctuation in gas supply).

### INDUSTRIAL APPLICABILITY

The technique of the invention is preferably applicable to a fuel cell system including fuel cells and a supply device provided for supply of a fluid required for power generation by the fuel cells.

1. An operating method of a fuel cell system that includes fuel cells and a supply device equipped with a driving device driven for supply of a fluid required for power generation by the fuel cells, the operating method driving the driving device included in the supply device to supply the fluid to the fuel cells,
the operating method comprising:
referring to a relation of a power generation amount to a supply amount of the fluid supplied to the fuel cells, and performing drive control of driving the driving device included in the supply device to supply the fluid of a supply amount corresponding to a power generation demand required for the fuel cells and power generation control of driving the fuel cells to give a power generation amount equivalent to the power generation demand from the fuel cells to an external load;
estimating a fluctuation in fluid supply induced by operation of the supply device during supply of the fluid from the supply device, based on an operating condition of the supply device; and
changing at least either the drive control of the supply device or the power generation control of the fuel cells according to the estimated fluctuation in fluid supply and thereby making a correction to relatively increase a rate of the supply amount of the fluid to the power generation amount,
wherein the correction made is at least either an increasing correction of increasing the supply amount of the fluid according to the estimated fluctuation in fluid supply or a decreasing correction of decreasing the power generation amount according to the estimated fluctuation in fluid supply,
in the increasing correction of the supply amount of the fluid made as the correction, the operating method enhancing a degree of the increasing correction of the supply amount of the fluid in response to a higher level of the estimated fluctuation in fluid supply and driving the driving device included in the supply device to supply the fluid of a corrected supply amount after the increasing correction,
in the decreasing correction of the power generation amount made the correction, the operating method enhancing a degree of the decreasing correction of the power generation amount given from the fuel cells to the external load in response to a higher level of the estimated fluctuation in fluid supply and driving the fuel cells to give a corrected power generation amount after the decreasing correction to the external load.

2. (canceled)

3. A fuel cell system including fuel cells and a supply device equipped with a driving device driven for supply of a fluid required for power generation by the fuel cells, the fuel cell system driving the driving device included in the supply device to supply the fluid to the fuel cells for power generation,
the fuel cell system comprising:
a supply amount computation module configured to refer to a relation of a power generation amount to a supply amount of the fluid supplied to the fuel cells and to compute a supply amount of the fluid corresponding to a power generation demand required for the fuel cells;
an equipment control module configured to control operation of the supply device to supply the fluid to the fuel cells; and
a supply correction module configured, in drive control of the supply device to supply the computed supply amount of the fluid by the equipment control module, to estimate a fluctuation in fluid supply induced by operation of the supply device based on an operating condition of the supply device and to make an increasing correction of the computed supply amount according to the estimated fluctuation in fluid supply,
wherein the supply correction module enhances a degree of the increasing correction of the computed supply amount in response to a higher level of the estimated fluctuation in fluid supply.

4. The fuel cell system in accordance with claim 3, wherein the supply amount computation module refers to a relation of the power generation amount to supply amounts of a hydrogen gas and of an oxygen-containing gas supplied as the fluid for power generation to the fuel cells and computes the supply amounts of the hydrogen gas and of the oxygen-containing gas corresponding to the power generation demand required for the fuel cells.

5. (canceled)

6. A fuel cell system including fuel cells and a supply device equipped with a driving device driven for supply of a fluid required for power generation by the fuel cells, the fuel cell system driving the driving device included in the supply device to supply the fluid to the fuel cells for power generation,
the fuel cell system comprising:
a supply amount detection module configured to detect a supply amount of the fluid supplied to the fuel cells;
a power generation amount computation module configured to refer to a relation of a power generation amount to the supply amount of the fluid supplied to the fuel cells and to compute a power generation amount corresponding to the detected supply amount;
a power generation control module configured to control operation of the fuel cells, so as to supply electric power generated by the fuel cells to an external load; and
a power generation correction module configured, in drive control of the fuel cells to obtain the computed power generation amount by the power generation control module, to estimate a fluctuation in fluid supply induced by operation of the supply device based on an operating condition of the supply device and to make a decreasing correction of the computed power generation amount according to the estimated fluctuation in fluid supply,
wherein the power generation amount computation module makes an increasing correction of the detected supply amount in such a manner as to enhance a degree of the increasing correction in response to a higher level of the estimated fluctuation in fluid supply, and computes the Dower generation amount corresponding to a corrected supply amount after the increasing correction,
the power generation correction module makes the decreasing correction of the power generation amount computed corresponding to the corrected supply amount after the increasing correction by the power generation amount computation module in such a manner as to enhance a degree of the decreasing correction in response to a higher level of the estimated fluctuation in fluid supply, and
the power generation control module compares a power generation demand required for driving the external load with a corrected power generation amount after the decreasing correction and controls the operation of the fuel cells with the smaller between the power generation demand and the corrected power generation amount after the decreasing correction.

7. The fuel cell system in accordance with claim 6, the power generation amount computation module refers to a relation of the power generation amount to a supply amount of at least a hydrogen gas out of the hydrogen gas and an oxygen-containing gas supplied as the fluid for power generation to the fuel cells, and computes the power generation amount corresponding to the detected supply amount.

8. (canceled)

9. The fuel cell system in accordance with claim 3, the fuel cell system further including:
a circulation system provided with a recycle flow path and arranged to flow back a fuel fluid discharged from the fuel cells to a fuel fluid supply system connecting with the fuel cells; and
a circulation pump provided in the recycle flow path of the circulation system and configured to recycle the discharged fuel fluid,
wherein the supply correction module estimates a fluctuation in recycle flow of the discharged fuel fluid induced by operation of the circulation pump and makes the increasing correction according to the estimated fluctuation in recycle flow and the estimated fluctuation in fluid supply.

10. The fuel cell system in accordance with claim 6, the fuel cell system further including:
a circulation system provided with a recycle flow path and arranged to flow back a fuel fluid discharged from the fuel cells to a fuel fluid supply system connecting with the fuel cells, where the circulation system is connected to the fuel fluid supply system in downstream of the supply amount detection module; and
a circulation pump provided in the recycle flow path of the circulation system and configured to recycle the discharged fuel fluid,
wherein the power generation correction module estimates a fluctuation in recycle flow of the discharged fuel fluid induced by operation of the circulation pump and makes the decreasing correction according to the estimated fluctuation in recycle flow and the estimated fluctuation in fluid supply.
